(19) United States
(12) Patent Application Publication
(10) Pub. No.: US 2026/0362054 A1
(43) Pub. Date: Nov. 12, 2026

(54) SPATIAL AUDIO COLLECTION METHOD AND APPARATUS

(71) Applicant: Beijing Xiaomi Mobile Software Co., Ltd., Beijing (CN)

(72) Inventor: Bin WANG, Beijing (CN)

(21) Appl. No.: 19/121,608

(22) PCT Filed: Oct. 19, 2022
(86) PCT No.: PCT/CN2022/126234

§ 371 Date: Apr. 16, 2025

(51) Int. Cl. H04R 3/00; H04R 5/027; H04S 7/00

(52) U.S. Cl. CPC H04R 3/005; H04R 5/027; H04S 7/307; H04S 2400/15

(57) ABSTRACT

The present disclosure relates to the technical field of mobile communications. Provided are a spatial audio collection method and apparatus. The method comprises: arranging a plurality of groups of mutually orthogonal microphone arrays in a UE, and performing differential beam processing on microphone signals acquired by the microphone arrays, so as to acquire a spatial audio signal. By means of the present disclosure, mutually orthogonal microphone arrays formed by miniature microphones that use a beam technique may be used, and the size of a spatial audio collection system is controlled to be within certain dimensions, such that the spatial audio collection system is built in an existing mobile device, and a pickup system that can be built in a mobile intelligent device is formed; in addition, the directivity of the microphone arrays is controlled by means of a differential beam technique, and additional electro-acoustic and acoustic hardware requirements are reduced, thereby meeting requirements for the mobile intelligent device regarding collecting immersive audio when the volume of the device is controlled.

### CROSS-REFERENCE TO RELATED APPLICATIONS

This application is a US national stage of International Application No. PCT/CN2022/126234, filed on Oct. 19, 2022, the content of which is hereby incorporated by reference in its entirety.

### TECHNICAL FIELD

The present disclosure relates to the field of mobile communication technologies, and in particular, to a spatial audio collection method and apparatus.

### BACKGROUND

With the development of technology, spatial audio is broadly applied to multimedia and instant messaging of civil equipment. However, at present, spatial audio is generally collected through external devices, and cannot be collected directly by an intelligent mobile device, and current spatial audio collection devices are bulky and difficult to operate, and hence cannot meet the increasing high-quality audio and video collection requirements of users.

### SUMMARY

A first aspect of embodiments of the present disclosure provides a spatial audio collection method, performed by a user equipment (UE), where microphone arrays are arranged in the UE, maximum response directions of the microphone arrays are orthogonal to each other, and the method includes: performing differential beamforming processing on a microphone signal collected by the microphone arrays to obtain a spatial audio signal.

In some embodiments, performing differential beamforming processing on the microphone signal collected by the microphone arrays to obtain the spatial audio signal includes: adding appropriate delay filtering and a corresponding compensation filter to the microphone signal to obtain an array signal with a required directivity; and decoding the array signal to obtain the spatial audio signal.

In some embodiments, the method further includes: acquiring directivities of the microphone arrays, where each of the directivities represents sensitivity of signals in different directions.

In some embodiments, the method further includes: acquiring differential arrays of the directivities; and acquiring a required directivity in a three-dimensional space through a combination of the differential arrays, to obtain the spatial audio signal.

In some embodiments, the method further includes: decoding the spatial audio signal to output an immersive multi-channel audio, or an ambisonic audio, or both.

In some embodiments, the method further includes: filtering the microphone signal to obtain a low-frequency component and a high-frequency component; where the low-frequency component is output as a low-frequency effect, and the high-frequency component is used to form the spatial audio signal.

In some embodiments, the microphone arrays are arranged in the UE through any one of following manners: the microphone arrays are arranged at a position close to a human voice collection component in the UE; or the microphone arrays are arranged at a position close to an image collection component in the UE.

In some embodiments, the microphone arrays include a predetermined number of microphones, the predetermined number of microphones form three microphone arrays, the three microphone arrays are orthogonal to each other or have an angular deviation error from orthogonality within a predetermined range, and centers of the three microphone arrays coincide or a distance between the centers does not exceed an error threshold.

A second aspect of embodiments of the present disclosure provides a spatial audio collection apparatus, arranged in a user equipment (UE), where microphone arrays are arranged in the UE, maximum response directions of the microphone arrays are orthogonal to each other, and the apparatus includes: a spatial audio signal collecting module, configured to perform differential beamforming processing on a microphone signal collected by the microphone arrays to obtain a spatial audio signal.

A third aspect of embodiments of the present disclosure provides a communication device, including: a transceiver; a memory; and a processor, connected to the transceiver and the memory respectively, and configured to control transceiving of wireless signals by the transceiver by executing a computer-executable instruction stored on the memory, and implement the spatial audio collection method according to the above first aspect of the embodiments.

A fourth aspect of embodiments of the present disclosure provides a computer storage medium, where the computer storage medium stores a computer-executable instruction; when the computer-executable instruction is executed by a processor, the spatial audio collection method according to the above first aspect of the embodiments is implemented.

Embodiments of the present disclosure provide a spatial audio collection method and apparatus, by which a spatial audio signal is obtained by arranging microphone arrays orthogonal to each other in a UE, and performing differential beam processing on a microphone signal collected by the microphone arrays. According to the present disclosure, by arranging the microphone arrays that are orthogonal to each other, a directivity of the microphones is controlled, and a size of the collecting system is controlled within a certain range, so as to embed the collecting system into a mobile device, to form a sound collecting system that can be embedded into a mobile intelligent device. Moreover, signals collected by the sound collecting system are controlled through differential beamforming technology to collect the spatial audio, and requirements of additional electroacoustic and acoustic hardware are reduced, so that requirement of the mobile intelligent device for collecting immersive audio is met in a case that the size of the device is controlled.

Additional aspects and advantages of the present disclosure will be set forth in part in the following description, which will become apparent from the following description, or understood by practice of the present disclosure.

### BRIEF DESCRIPTION OF DRAWINGS

The above and/or additional aspects and advantages of the present disclosure will become apparent and readily understood from the following description of embodiments with reference to the accompanying drawings.

FIG. 1 is a schematic flowchart of a spatial audio collection method according to an embodiment of the present disclosure.

FIG. 2 is a schematic flowchart of a spatial audio collection method according to an embodiment of the present disclosure.

FIG. 3 is a schematic diagram of spatial audio collection logic according to an embodiment of the present disclosure.

FIG. 4 is a schematic diagram of a first-order differential array according to an embodiment of the present disclosure.

FIGS. 5A-5C are schematic diagrams of directivities of microphone arrays according to an embodiment of the present disclosure.

FIGS. 6A-6B are schematic diagrams of directivities of decoded left and right channels according to an embodiment of the present disclosure.

FIG. 7 is a schematic diagram of a first-order B format according to an embodiment of the present disclosure.

FIG. 8 is a schematic diagram of signal components of a first-order B-format directivity according to an embodiment of the present disclosure.

FIG. 9A-9B are schematic diagrams of an arrangement of microphone arrays in a mobile device according to an embodiment of the present disclosure.

FIG. 10A-10B are schematic diagrams of an arrangement of microphone arrays in a mobile device according to an embodiment of the present disclosure.

FIG. 11 is a schematic block diagram of a spatial audio collection apparatus according to an embodiment of the present disclosure.

FIG. 12 is a schematic structural diagram of a communication apparatus according to an embodiment of the present disclosure.

FIG. 13 is a schematic structural diagram of a chip according to an embodiment of the present disclosure.

### DETAILED DESCRIPTION

Embodiments of the present disclosure are described in detail below, and examples of the embodiments are illustrated in the accompanying drawings, where same or similar reference numerals refer to same or similar elements or elements having same or similar functions throughout. The embodiments described below with reference to the accompanying drawings are examples and are intended to explain the present disclosure, and cannot be construed as limiting the present disclosure.

With the development of technology, spatial audio is broadly applied to civil equipment, and websites such as YouTube and Facebook all support spatial audio content. For real-time communication, audio and video encoding and decoding such as AVS (Audio Video Coding Standard) supports encoding and decoding of spatial audio.

Although the existing spatial audio collection technology can achieve good audio quality and immersive sound field reproduction, the current spatial audio collection depends on an external device and cannot be directly collected through an intelligent mobile device. In addition, the current spatial collection device is bulky and difficult to operate. The following table shows 3D (three-dimensional) spatial audio collection devices in related arts:

| | Audio format | | | |
|---|---|---|---|---|
| | Ambisonic | Ambisonic | Multi-channel | Multi-channel |
| | Current product | | | |
| | | Core Sound | DPA 5100 Mobile | |
| | ZYLIA ZM-1 | Octomic | 5.1 Surround Mic | Schops ortf-3d |
| Size | Height: 155 mm | Height: 127 mm | Height: 140 mm | 42 cm × 21 cm × 32 |
| | Length: 103 mm | Diameter: 17.7 mm | Width: 240 mm | cm |
| | | | Length: 195 mm | |

It can be seen that the spatial audio collection device in the related art cannot be built into an existing mobile intelligent device, and cannot meet the increasing high-quality audio and video collection requirements of users. Taking a most common mobile intelligent device, smart phone, as an example, a size thereof is about 7 inches, such as Xiaomi 12S PRO (length 163.6 mm, width 74.6 mm, thickness 8.16 mm). In addition, due to compact hardware arrangement in the mobile intelligent device, the built-in audio collection system of the mobile intelligent device has a very limited size.

To this end, the present disclosure provides a spatial audio collection method and apparatus, to solve the problem, in the prior art, that a spatial audio collection system cannot be integrated into user equipment (UE) for effective and high-quality spatial audio collection.

The spatial audio collection method and apparatus provided in the present disclosure are described in detail below with reference to the accompanying drawings.

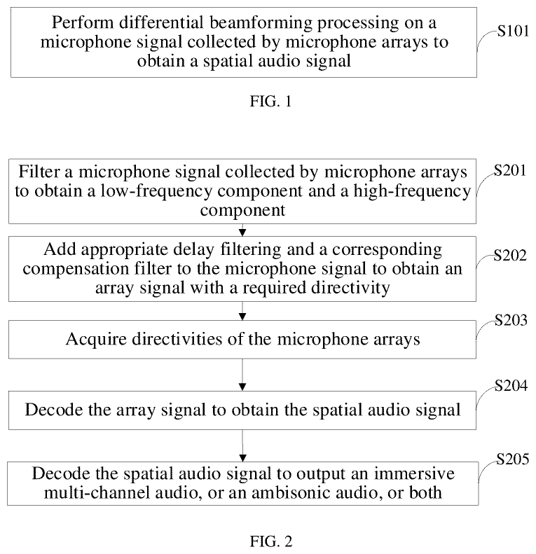

FIG. 1 shows a schematic flowchart of a spatial audio collection method according to an embodiment of the present disclosure. The method may be performed by a user equipment (UE). In the present disclosure, the UE is arranged with multiple microphone arrays, and maximum response directions of the multiple microphone arrays are orthogonal to each other. As shown in FIG. 1, the method may include:
S101, performing differential beamforming processing on a microphone signal collected by the microphone arrays to obtain a spatial audio signal.

In an embodiment of the present disclosure, multiple microphone arrays that are orthogonal to each other are provided in the UE, and each microphone array may include a plurality of microphones. A type of the microphone is not limited in the present disclosure, and an omnidirectional miniature microphone with small size, small error, suitable for being integrated into small devices such as user equipment, and suitable for beam control, such as an MEMS (Micro-Electro-Mechanical System) microphone or an electret microphone, can be adopted, so as to control a size of the sound collecting system, and compared to previous spatial audio collection devices, by adopting the omnidirectional miniature microphone, the present disclosure can greatly reduce a size of the spatial audio collection system.

Conventional microphone beams can be processed through delay-sum, filter-sum, adaptive beamforming (Minimum Variance Distortionless Response, MVDR), and differential beamforming. The differential beamforming has advantages of compact layout and frequency-invariant beam pattern. In an embodiment of the present disclosure, for the multiple microphone arrays, directivity may be controlled by a differential microphone beamforming technology to assist in acquiring spatial audio signals. In the present disclosure, the directivity required in the three-dimensional space is obtained by combining different low-order arrays through different differential beamforming designs, thereby collecting spatial audio signals. According to the solution of the present disclosure, the directivity is controlled only through the beam technology, and the dependence of the sound collecting system on electroacoustic and acoustic hardware can be effectively reduced.

Therefore, according to the spatial audio collection method provided by the present disclosure, by arranging microphone arrays orthogonal to each other in a UE, and performing differential beam processing on a microphone signal collected by the microphone arrays, a spatial audio signal is obtained. By means of the present disclosure, mutually orthogonal microphone arrays formed by miniature microphones that use a beam technique may be used, and the size of a spatial audio collection system is controlled to be within certain dimensions, such that the spatial audio collection system is built in an existing mobile device, and a sound collection system that can be built in a mobile intelligent device is formed; in addition, the directivity of the microphone arrays is controlled by means of a differential beam technique, and additional electro-acoustic and acoustic hardware requirements are reduced, thereby meeting requirements for the mobile intelligent device regarding collecting immersive audio when the size of the device is controlled.

FIG. 2 shows a schematic flowchart of a spatial audio collection method according to an embodiment of the present disclosure. The method may be performed by a UE, and in the embodiments of the present disclosure, an arrangement manner of microphone arrays is first described.

In some optional embodiments, the microphone arrays include a predetermined number of microphones, the predetermined number of microphones form three microphone arrays, the three microphone arrays are orthogonal to each other or have an angular deviation error from orthogonality within a predetermined range, and centers of the three microphone arrays coincide or a distance between the centers does not exceed an error threshold.

In other words, the number of microphones in the microphone array is not limited in the present disclosure, and each array may be composed of any number of microphones. In a preferred embodiment, 4 MEMS microphones are of a cost-optimal design, for example, the 4 MEMS microphones are arranged on 4 adjacent vertices of a regular hexahedron to form three microphone arrays orthogonal to each other.

A type of the microphone is not limited in the present disclosure, a miniature microphone (such as MEMS) can be used to control the size of the sound collecting system, and compared with conventional spatial audio collection devices, the solution provided by the present disclosure can greatly reduce the size.

It should be understood that the three microphone arrays are arranged at an orthogonal angle as a preferred mode of the present disclosure, and in some alternative embodiments, the three microphones may have a certain angle offset, and centers of the three microphone arrays completely coincide in an ideal state, and in some alternative embodiments, separation or a certain distance between the centers may be considered as an error. Certainly, the microphone arrays in actual device should be kept orthogonal to each other, thereby reducing interference caused by position errors. In addition, since position error, inconsistency between microphones, and interference of the device itself affect final performance, calibration needs to be performed according to actual conditions.

For example, the present disclosure arranges 3 pairs of microphones orthogonal to each other by using omni-directional micro-microphones with fully consistent parameters, and midpoints of lines connecting each pair of microphones coincide. The microphones forming the arrays can be multiplexed, so at least 4 microphones are needed to form the microphone arrays required by the present disclosure, and the microphone arrays are arranged at any 4 vertexes of a regular hexahedron. Due to size limitation of the mobile intelligent device, a preferred embodiment of the present disclosure recommends to arrange 4 microphones on 4 adjacent vertices of the regular hexahedron, principal axis directions of the microphones are consistent, and the microphone array spacing is as small as possible.

In this example, a three-dimensional spatial coordinate system is established with a microphone 0 as an origin, a microphone 1 is on an x-axis, a microphone 2 is on a y-axis, and a microphone 3 is on a z-axis. The 3 groups of microphones 0 and 1, 2 and 3 are equally spaced to form 3 pairs of orthogonal first-order differential arrays. Since the miniature microphone has the advantage of small size compared with the traditional capacitive and moving-coil microphones, the 3 pairs of microphones can be easily controlled with a 4 mm spacing, which is much smaller than a wavelength (1.7 cm) of a target signal (20-20 kHz), so an error caused by the microphone spacing is negligible.

Based on the embodiments shown in FIG. 1, as shown in FIG. 2, the method may include S201-S205.
S201, filtering a microphone signal collected by microphone arrays to obtain a low-frequency component and a high-frequency component.

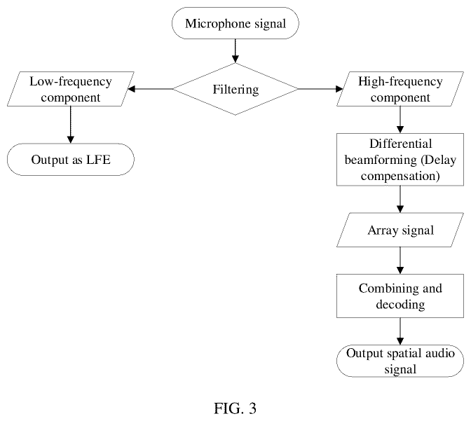

In an embodiment of the present disclosure, filtering processing is performed on the microphone signal acquired by the microphone arrays, the obtained low-frequency component is output as a low-frequency effect, and the high-frequency component is used for subsequent processing to form a spatial audio signal, as shown in FIG. 3, FIG. 3 shows a schematic diagram of spatial audio collection logic described in the present disclosure.

It should be understood that, due to a high-pass characteristic of the differential beam, the low-frequency part is poor, thus a low-frequency component of an original signal of the microphone 0 (that is, a microphone signal obtained by the microphone array) may be reserved to be used as an LFE (low frequency effect) sound channel. As the low-frequency component has a long wavelength, the low-frequency component has less influence on positioning of human ears and hence does not influence a sense of space when the low-frequency effect is increased. For remaining channels, the microphone signal filtered by removing the low-frequency component through a high-pass filter is used as the high-frequency component, and is used for subsequent processing to form the spatial audio signal.
S202, adding appropriate delay filtering and a corresponding compensation filter to the microphone signal to obtain an array signal with a required directivity.

It should be understood that, for the high-frequency component obtained in step S201, appropriate delay filtering and a corresponding compensation filter may be added to obtain the array signal with the required directivity.
S203, acquiring directivities of the microphone arrays.

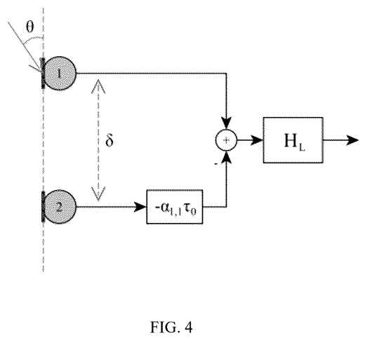

In an embodiment of the present disclosure, each directivity represents sensitivity of signals in different directions. According to the present disclosure, differential arrays with multiple directivities are obtained, and a directivity required in a three-dimensional space is obtained by combining different differential arrays, as shown in FIG. 4, FIG. 4 shows a schematic diagram of a first-order differential array.

Specifically, steps S202-S203 are described in detail below.

For a standard first-order differential array, a target signal is obtained by subtracting microphone signals of two microphones with a same principal axis direction, and a directivity is controlled by adding a delay with a constant angular frequency to the subtracted microphone signal.

First, let

$$\frac{δ}{c} = {τ}_{0} ,$$

where δ represents a spacing between the microphones, and c represents a sound speed, and τ₀ represents a phase difference.

An output compensation filter may be represented as:

$${H}_{L} ( ω ) = \frac{j}{( {α}_{1 , 1} - 1 ) {τ}_{0} ω} ,$$

where ω represents an angular frequency, ∝_{1,1} represents a coefficient of the delay filter, and j=\sqrt{−1}.

Therefore, for a signal at an angle θ (an incident angle from a sound source to the microphone), a signal output by the array (i.e., the array signal described above) is represented as: Y(ω,θ)=(X₁(ω,θ)−X₂(ω,θ))H_{L}(ω), where Xₙ(ω,θ) represents an n-th microphone signal.

Since the microphone spacing is much smaller than the wavelength, τ₀−∝_{1,1}τ₀<<2π, the amplitude difference between X₁, X₂ can be ignored, and e^{x}=1+x.

Thus, the signal Y(ω,θ) output by the array may be represented as:

$$Y ( ω , θ ) = {X}_{1} ( ω , θ ) ( 1 - {e}^{- j ω {τ}_{0} ( cos θ - {α}_{1 , 1} )} ) \frac{j}{( {α}_{1 , 1} - 1 ) {τ}_{0} ω} .$$

The directivity of the array (sensitivity to signals in different directions) is represented as:

$$B ( ω , θ ) = ( 1 - {e}^{- j ω {τ}_{0} ( cos θ - {α}_{1 , 1} )} ) \frac{j}{( {α}_{1 , 1} - 1 ) {τ}_{0} ω} .$$

By simplifying, it is represented as:

$$B ( ω , θ ) = \frac{1}{1 - {α}_{1 , 1}} ( cos θ - {α}_{1 , 1} ) .$$

The two most common directivities are (with a principal axis direction of 90°):

| Directivity | α_{1, 1} | Angle with 0 sensitivity |
|---|---|---|
| Figure-8\Bi-directional | 0 | 0°, 180° |
| Cardioid | −1 | −90° |

Therefore, the directivity of the differential beam can be controlled by controlling the delay filter coefficient.
S204, decoding the array signal to obtain the spatial audio signal.

In the embodiment of the present disclosure, according to the principle of the differential array, 3 pairs of microphones may constitute the following 5 first-order differential arrays with different directivities:

| | Direction of principal | | |
|---|---|---|---|
| No. | axis | Directivity | Selected microphones |
| Array 1 | Positive direction of | Cardioid | Microphones 0 and 1 |
| | X axis | | |
| Array 2 | Negative direction of | Cardioid | Microphones 0 and 1 |
| | X axis | | |
| Array 3 | Positive direction of | Figure-8 | Microphones 0 and 2 |
| | Y axis | | |
| Array 4 | Positive direction of | Figure-8 | Microphones 0 and 3 |
| | Z axis | | |
| Array 5 | Positive direction of | Figure-8 | Microphones 0 and 1 |
| | X axis | | |

A required directivity in a three-dimensional space is obtained by combining the first-order arrays, so as to collect the spatial audio signal.
S205, decoding the spatial audio signal to output an immersive multi-channel audio, or an ambisonic audio, or both.

In the embodiments of the present disclosure, audio signals required by spatial audio are obtained through different differential beam designs. For example, different audio formats such as multi-channel audio and ambisonic (B-format) may be output, where the multi-channel audio and ambisonic audio are two formats of immersive audio (surround sound).

For example, in an optional embodiment, an MIS (Mid\Side)-3D recording mode is constructed based on an M\S recording principle, and a 5.1.4-channel multi-channel audio is output by decoding a spatial audio signal. Two arrays with opposite cardioid polar patterns are directed forward and backward of the X-axis, and two arrays with figure-8 polar pattern are directed forward of the Y-axis and forward of the Z-axis respectively.

A decoding manner to obtain the multi-channel audio is as follows, where “+” represents to add a signal, and “−” represents to add a negative phase of a signal.

| Channel | Array 1 | Array 2 | Array 3 | Array 4 |
|---|---|---|---|---|
| Left | + | | + | − |
| Center | + | | | |
| Right | + | | − | − |
| Left surround | | + | + | |
| Right surround | | + | − | − |
| Left front overhead | + | | + | + |
| Right front overhead | + | | | + |
| Left rear overhead | | + | + | + |
| Right rear overhead | | + | − | + |

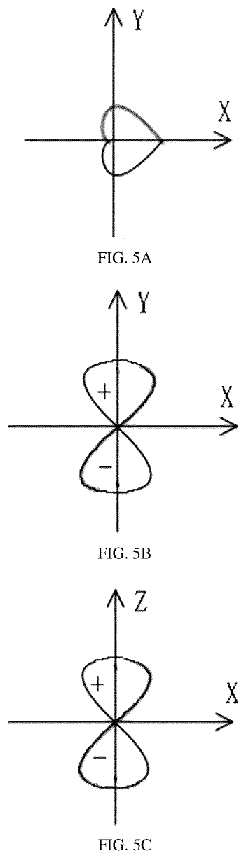

The arrangement manner of the microphone arrays proposed in the present disclosure is as shown in the above five arrays, where directivity of array 1 in shown in xoy-plane in FIG. 5A; directivity of array 3 is shown in xoy-plane in FIG. 5B, where “+” represents a positive phase and “−” represents a negative phase, and same positive and negative phase signals will cancel each other out; directivity of array 4 is shown in xoz-plane in FIG. 5C, where “+” represents a positive phase and “−” represents a negative phase, and same positive and negative phase signals will cancel each other out.

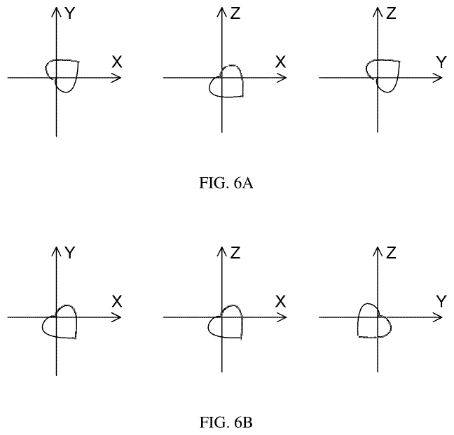

After decoding, directivities of left channel and right channel are shown in the coordinate axis planes in FIG. 6, where the left channel is shown in FIG. 6A, and the right channel is shown in FIG. 6B.

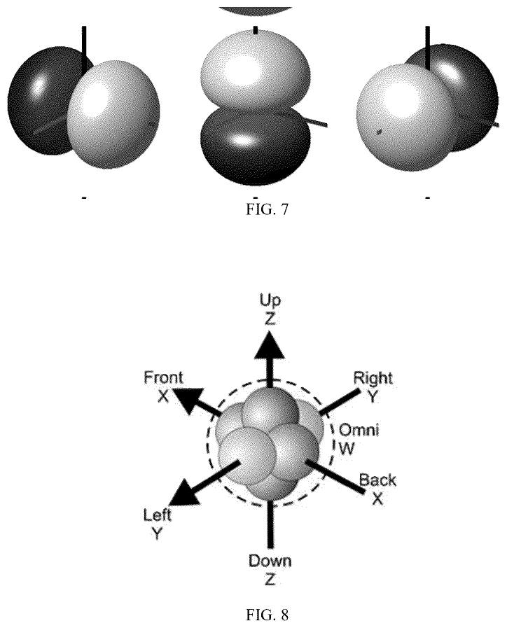

In another embodiment of the present disclosure, the present disclosure may output standard ambisonic audio. It should be understood that the first-order B-format is a first-order decomposition of spherical harmonics, as shown in FIG. 7. A standard B-format requires an omni-directional signal (W) and three mutually orthogonal bi-directional (figure-8) signals (X, Y, Z). The four components required by the B format are obtained by selecting the corresponding array, which may be represented as: W=microphone 0; X=array 1; Y=array 2; Z=array 5, as shown in FIG. 8.

Therefore, the spatial audio signals are decoded to obtain the audio signals in different formats, so as to meet the diversity requirement of spatial audio collection.

In addition, in an optional example, the microphone arrays may be arranged in the UE according to actual needs.

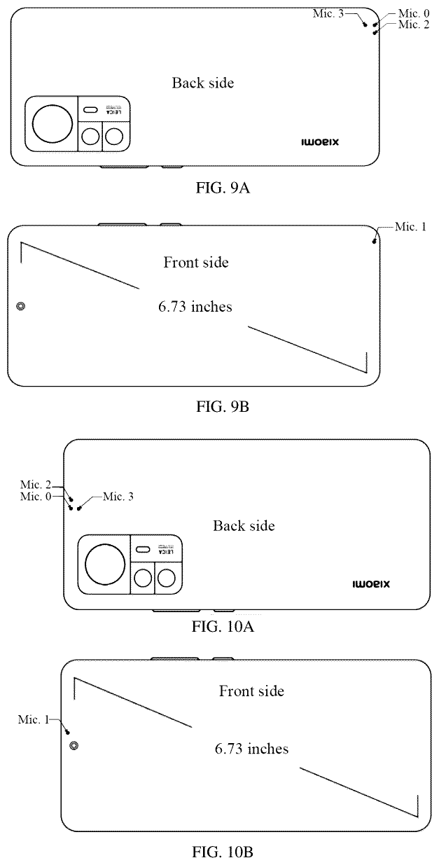

In an example, when the handheld call requirement is considered, the microphone arrays are arranged in the UE close to the human voice collection component. For example, the microphone arrays are arranged at the lower end of the mobile intelligent device close to the human mouth to ensure a better signal-to-noise ratio, as shown in FIGS. 9A-9B, which shows a schematic diagram of the arrangement of the microphone arrays in the mobile device, where FIG. 9A shows a schematic diagram of a back side of the mobile device, and FIG. 9B shows a schematic diagram of a front side.

In another example, when the video effect is considered, the microphone arrays are arranged at a position close to an image collection component in the UE. For example, the microphone arrays are arranged close to the camera and is consistent with a forward direction of the camera. By ensuring a viewing angle of the camera is as consistent as possible, a better audio-visual effect is ensured. FIGS. 10A-10B shows a schematic diagram of an arrangement of microphone arrays in a mobile device, where FIG. 10A shows a schematic diagram of a back side of the mobile device, and FIG. 10B shows a schematic diagram of a front side.

As described above, according to the spatial audio collection method provided by the present disclosure, by arranging microphone arrays orthogonal to each other in a UE, and performing differential beam processing on a microphone signal collected by the microphone arrays, a spatial audio signal is obtained. By means of the present disclosure, mutually orthogonal microphone arrays formed by miniature microphones that use a beam technique may be used, and the size of a spatial audio collection system is controlled to be within certain dimensions, such that the spatial audio collection system is built in an existing mobile device, and a sound collection system that can be built in a mobile intelligent device is formed; in addition, the directivity of the microphone arrays is controlled by means of a differential beam technique, and additional electro-acoustic and acoustic hardware requirements are reduced, thereby meeting requirements for the mobile intelligent device regarding collecting immersive audio when the size of the device is controlled. In addition, different application requirements can be met by outputting audio in different formats, and the microphone array can adapt to different application scenes by arranging the microphone array at different positions in the mobile device.

In the above embodiments provided in the present disclosure, the method provided in the embodiments of the present disclosure are described from a perspective of a user equipment. To implement functions in the method provided in the above embodiments of the present disclosure, the user equipment may include a hardware structure and a software module, and the functions are implemented in a form of the hardware structure, the software module, or the hardware structure plus the software module. A function in the above functions may be performed by using a hardware structure, a software module, or a hardware structure plus a software module.

Corresponding to the spatial audio collection method provided in the above embodiments, the present disclosure further provides a spatial audio collection apparatus, and as the spatial audio collection apparatus provided in the embodiments of the present disclosure corresponds to the spatial audio collection method provided in the above embodiments, implementations of the spatial audio collection method is also applicable to the spatial audio collection apparatus provided in the embodiments, and details will not be repeated in the embodiment.

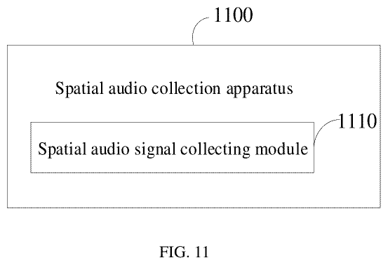

FIG. 11 is a schematic structural diagram of a spatial audio collection apparatus 1100 provided by an embodiment of the present disclosure, the spatial audio collection apparatus 1100 is arranged in a user equipment (UE), microphone arrays are arranged in the UE, and maximum response directions of the microphone arrays are orthogonal to each other.

As shown in FIG. 11, the apparatus 1100 includes: a spatial audio signal collecting module 1110, configured to perform differential beamforming processing on a microphone signal collected by the microphone arrays to obtain a spatial audio signal.

According to the spatial audio collection apparatus, by arranging microphone arrays orthogonal to each other in a UE, and performing differential beam processing on a microphone signal collected by the microphone arrays, a spatial audio signal is obtained. By means of the present disclosure, mutually orthogonal microphone arrays formed by miniature microphones that use a beam technique may be used, and the size of a spatial audio collection system is controlled to be within certain dimensions in a case that the directivity of the microphones is controlled, such that the spatial audio collection system is built in an existing mobile device, and a sound collection system that can be built in a mobile intelligent device is formed; in addition, the directivity of the signals collected by the sound collecting system is controlled by means of a differential beam technique, and additional electro-acoustic and acoustic hardware requirements are reduced, thereby meeting requirements for the mobile intelligent device regarding collecting immersive audio when the size of the device is controlled.

In some embodiments, the spatial audio signal collecting module 1110 is further configured to: add appropriate delay filtering and a corresponding compensation filter to the microphone signal to obtain an array signal with a required directivity; and decode the array signal to obtain the spatial audio signal.

In some embodiments, the spatial audio signal collecting module 1110 is further configured to: acquire directivities of the microphone arrays, where each of the directivities represents sensitivity of signals in different directions.

In some embodiments, the spatial audio signal collecting module 1110 is further configured to: acquire differential arrays of the directivities; and acquire a required directivity in a three-dimensional space through a combination of the differential arrays, to obtain the spatial audio signal.

In some embodiments, the spatial audio signal collecting module 1110 is further configured to: decode the spatial audio signal to output an immersive multi-channel audio, or an ambisonic audio, or both.

In some embodiments, the spatial audio signal collecting module 1110 is further configured to: filter the microphone signal to obtain a low-frequency component and a high-frequency component; where the low-frequency component is output as a low-frequency effect, and the high-frequency component is used to form the spatial audio signal.

In some embodiments, the microphone arrays are arranged in the UE through any one of following manners: the microphone arrays are arranged at a position close to a human voice collection component in the UE; or the microphone arrays are arranged at a position close to an image collection component in the UE.

In some embodiments, the microphone arrays include a predetermined number of microphones, the predetermined number of microphones form three microphone arrays, the three microphone arrays are orthogonal to each other or have an angular deviation error from orthogonality within a predetermined range, and centers of the three microphone arrays coincide or a distance between the centers does not exceed an error threshold.

According to the spatial audio collection apparatus, by arranging microphone arrays orthogonal to each other in a UE, and performing differential beam processing on a microphone signal collected by the microphone arrays, a spatial audio signal is obtained. By means of the present disclosure, mutually orthogonal microphone arrays formed by miniature microphones that use a beam technique may be used, and the size of a spatial audio collection system is controlled to be within certain dimensions in a case that the directivity of the microphones is controlled, such that the spatial audio collection system is built in an existing mobile device, and a sound collection system that can be built in a mobile intelligent device is formed; in addition, the directivity of the signals collected by the sound collecting system is controlled by means of a differential beam technique, and additional electro-acoustic and acoustic hardware requirements are reduced, thereby meeting requirements for the mobile intelligent device regarding collecting immersive audio when the size of the device is controlled. In addition, different application requirements can be met by outputting audio in different formats, and the microphone array can adapt to different application scenes by arranging the microphone array at different positions in the mobile device.

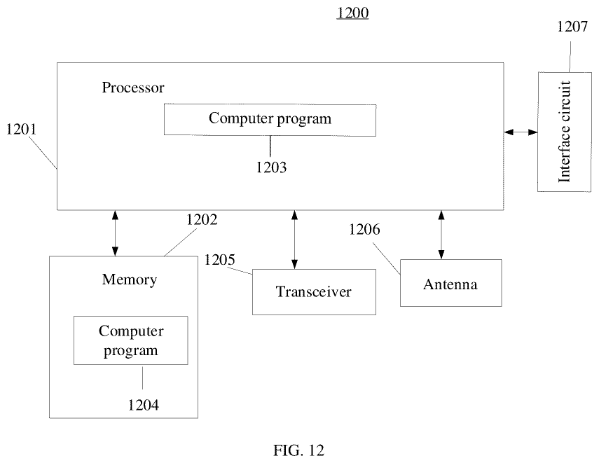

Referring to FIG. 12, FIG. 12 is a schematic structural diagram of a communication apparatus 1200 according to an embodiment of the present disclosure. The communication apparatus 1200 may be a network device, or a user device, or a chip, a chip system or a processor that supports the network device to implement the above method, or a chip, a chip system or a processor that supports the user device to implement the above method. The apparatus can be configured to implement the method described in the above method embodiments, and specific descriptions can be referred from the above method embodiments.

The communication apparatus 1200 may include one or more processors 1201. The processor 1201 may be a general-purpose processor, a special-purpose processor, or the like. For example, the processor 1201 may be a baseband processor or a central processing unit. The baseband processor may be configured to process a communication protocol and communication data, and the central processing unit may be configured to control a communication apparatus (for example, a base station, a baseband chip, a terminal device, a terminal device chip, a DU, or a CU), execute a computer program, and process data of the computer program.

Optionally, the communication apparatus 1200 may further include one or more memories 1202, where the one or more memories 1202 may store a computer program 1204, and the processor 1201 executes the computer program 1204, to cause the communication apparatus 1200 to perform the method described in the above method embodiments. Optionally, the memory 1202 may further store data. The communication apparatus 1200 and the memory 1202 may be separately disposed, or may be integrated together.

Optionally, the communication apparatus 1200 may further include a transceiver 1205 and an antenna 1206. The transceiver 1205 may be referred to as a transceiver unit, a transceiver device, a transceiver circuit, or the like, and is configured to implement a transceiving function. The transceiver 1205 may include a receiver and a transmitter, where the receiver may be referred to as a receiving device or a receiving circuit, and is configured to implement a receiving function; and the transmitter may be referred to as a transmitting device or a transmitting circuit, and is configured to implement a transmitting function.

Optionally, the communication apparatus 1200 may further include one or more interface circuits 1207. The interface circuits 1207 are used to receive a code instruction and transmit the code instruction to the processor 1201. The processor 1201 runs the code instruction to cause the communication apparatus 1200 to perform the method described in the above method embodiments.

In an implementation, the processor 1201 may include a transceiver configured to implement receiving and sending functions. For example, the transceiver may be a transceiver circuit, an interface, or an interface circuit. The transceiver circuit, the interface, or the interface circuit for implementing the receiving and sending functions may be separate or integrated together. The transceiver circuit, the interface, or the interface circuit may be configured to read and write code/data, or the transceiver circuit, the interface, or the interface circuit may be configured to transmit or transmit a signal.

In an implementation, the processor 1201 can store a computer program 1203, and the computer program 1203 runs on the processor 1201, to cause the communication apparatus 1200 to perform the method described in the above method embodiments. The computer program 1203 may be solidified in the processor 1201, in which case, the processor 1201 may be implemented by hardware.

In an implementation, the communication apparatus 1200 may include a circuit, which may realize the function of sending or receiving or communicating in the above method embodiments. The processor and transceiver described in the present disclosure can be implemented in an integrated circuit (IC), an analog IC, a radio frequency integrated circuit (RFIC), a mixed-signal IC, an application specific integrated circuit (ASIC), a printed circuit board (PCB), an electronic device, and the like. The processor and transceiver can also be manufactured by various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or a user equipment, but a scope of the communication apparatus described in the present disclosure is not limited thereto, and a structure of the communication apparatus may not be limited in FIG. 12. The communication apparatus may be a stand-alone device or may be a part of a larger device. For example, the communication apparatus may include:
(1) stand-alone integrated circuit (IC), or chip, or chip system or subsystem;
(2) a set of one or more ICs, optionally, the IC set may also include storage components for storing data and computer programs;
(3) ASIC (Application Specific Integrated Circuit), such as a modem;
(4) a module that can be embedded in other devices;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others, etc.

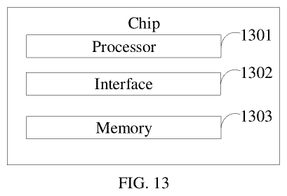

In a case that the communication apparatus may be a chip or a chip system, the schematic structural diagram of the chip shown in FIG. 13 can be referred to. The chip shown in FIG. 13 includes a processor 1301 and an interface 1302. There may be one or more processors 1301, and one or more interfaces 1302.

Optionally, the chip further includes a memory 1303 for storing necessary computer programs and data.

Those skilled in the art can also understand that various illustrative logical blocks and steps listed in the embodiments of the present disclosure can be implemented by electronic hardware, computer software, or a combination of both. Whether this function is implemented by hardware or software depends on the specific application and the design requirements of the whole system. Those skilled in the art can use various methods to realize the described functions for each specific application, but this realization should not be understood as beyond the scope of protection of the embodiments of the present disclosure.

The present disclosure also provides a readable storage medium, storing an instruction, where when the instruction is executed by a computer, a function of any one of the above method embodiments is implemented.

The present disclosure also provides computer program product, where when the computer program product is executed by a computer, a function of any one of the above method embodiments is implemented.

The above embodiments can be implemented in whole or in part by software, hardware, firmware or any combination thereof. When implemented in software, the embodiments can be fully or partially implemented in a form of a computer program product. The computer program product includes one or more computer programs.

When the computer program is loaded and executed on a computer, a procedure or function according to the embodiment of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, a computer, a server or a data center to another website, a computer, a server or a data center, through a wired manner (e.g., a coaxial cable, an optical fiber, a digital subscriber line) or a wireless manner (infrared, wireless, microwave). The computer-readable storage medium may be any available medium that a computer can access, or a data storage device such as a server, a data center and the like integrated by one or more available medium. The available medium may be a magnetic medium (e.g., floppy disk, hard disk, magnetic tape), an optical medium (e.g., high-density digital video disc (DVD)), or a semiconductor medium (e.g., solid state disk (SSD)) and the like.

It can be understood by those skilled in the art that the “first”, “second” and other numerical numbers involved in the present disclosure are only for the convenience of description, and are not used to limit the scope of the embodiments of the present disclosure, but also indicate the order.

The “at least one of” in the present disclosure can also be described as one or more, and “a plurality of” may be two, three, four or more, which is not limited in the present disclosure. In the embodiments of the present disclosure, for a technical feature, technical features in the technical feature are distinguished by “first”, “second”, “third”, “A”, “B”, “C” and “D”. The technical features described by “first”, “second”, “third”, “A”, “B”, “C” and “D” are not ordered in sequence or in size.

As used herein, the terms “machine-readable medium” and “computer-readable medium” refer to any computer program product, apparatus, and/or device (e.g., magnetic disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with implementations of the systems and techniques described herein), or a computing system including any combination of such background components, middleware components, or front-end components. The components of the system may be interconnected by any form or medium of digital data communication (e.g., communication network). Examples of communication networks include a local area network (LAN), a wide area network (WAN), and the Internet.

The computer system may include a client and a server. The client and the server are generally remote from each other and typically interact over a communication network. The client and server relationships are generated by computer programs running on respective computers and having client-server relationships with each other.

It should be understood that various forms of processes shown above may be used by reordering, adding or deleting steps. For example, the steps described in the present disclosure may be performed in parallel or sequentially, or may be performed in a different order, as long as a desired result of the technical solutions disclosed in the present disclosure can be implemented, which is not limited herein.

In addition, it should be understood that various embodiments of the present disclosure may be implemented separately, or may be implemented in combination with other embodiments when the solution allows.

Those skilled in the art may notice that the units and algorithm steps of various examples described in connection with the embodiments disclosed herein can be implemented in electronic hardware, or a combination of computer software and electronic hardware. Whether these functions are implemented in hardware or software depends on the specific application and design constraints of the technical solution. Those skilled in the art can use different manners to implement the described functions for each specific application, but such implementation should not be considered beyond the scope of the present disclosure.

It can be clearly understood by those skilled in the art that for the convenience and conciseness of description, the specific working processes of the systems, devices and units described above can refer to the corresponding processes in the above method embodiments, and will not be repeated herein.

The above is only the specific implementation of the present disclosure, but the protection scope of the present disclosure is not limited thereto. Any person familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A method for collecting a spatial audio, performed by a user equipment (UE), wherein microphone arrays are arranged in the UE, maximum response directions of the microphone arrays are orthogonal to each other, and the method comprises:
performing differential beamforming processing on a microphone signal collected by the microphone arrays to obtain a spatial audio signal.

2. The method according to claim 1, wherein performing differential beamforming processing on the microphone signal collected by the microphone arrays to obtain the spatial audio signal comprises:
adding delay filtering and a corresponding compensation filter to the microphone signal to obtain an array signal with a required directivity; and
decoding the array signal to obtain the spatial audio signal.

3. The method according to claim 2, further comprising:
acquiring directivities of the microphone arrays, wherein each of the directivities represents sensitivity of signals in different directions.

4. The method according to claim 3, further comprising:
acquiring differential arrays of the directivities; and
acquiring a required directivity in a three-dimensional space by combining the differential arrays, to obtain the spatial audio signal.

5. The method according to claim 1, further comprising:
decoding the spatial audio signal to output an immersive multi-channel audio, or an ambisonic audio, or both.

6. The method according to claim 1, further comprising:
filtering the microphone signal to obtain a low-frequency component and a high-frequency component;
wherein the low-frequency component is output as a low-frequency effect, and the high-frequency component is used to form the spatial audio signal.

7. The method according to claim 1, wherein the microphone arrays are arranged in the UE through any one of following manners:
the microphone arrays are arranged at a position close to a human voice collection component in the UE; or
the microphone arrays are arranged at a position close to an image collection component in the UE.

8. The method according to claim 1, wherein the microphone arrays comprise a predetermined number of microphones, the predetermined number of microphones form three microphone arrays, the three microphone arrays are orthogonal to each other or have an angular deviation error from orthogonality within a predetermined range, and centers of the three microphone arrays coincide or a distance between the centers does not exceed an error threshold.

9. A spatial audio collection apparatus, arranged in a user equipment (UE), wherein microphone arrays are arranged in the UE, maximum response directions of the microphone arrays are orthogonal to each other, and the apparatus comprises:
a processor; and
a memory storing instructions executable by the processor,
wherein the processor is configured to perform differential beamforming processing on a microphone signal collected by the microphone arrays to obtain a spatial audio signal.

10. A communication device, comprising:
a transceiver;
a memory; and
a processor, connected to the transceiver and the memory respectively, and configured to perform the method according to claim 1.

11. A non-transitory computer storage medium storing a computer-executable instruction that, when executed by a processor, causes the processor to perform the method according to claim 1.
